(19) United States
(12) Patent Application Publication
(10) Pub. No.: US 2009/0066634 A1
(43) Pub. Date: Mar. 12, 2009

(54) LIGHTING DEVICE FOR DISPLAY DEVICE AND CONTROL CIRCUIT THEREOF

(75) Inventors: Hiroaki Isobe, Mie (JP); Tetsuya Hamada, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/297,329

(22) PCT Filed: Dec. 25, 2006
(86) PCT No.: PCT/JP2006/325714

§ 371 Date: Oct. 16, 2008

(30) Foreign Application Priority Data
Jun. 19, 2006 (JP) 2006-168547

(51) Int. Cl. G09G 3/36; G09G 3/22

(52) U.S. Cl. 345/102; 315/151

(57) ABSTRACT

In a lighting device for a display device, sensor output determination portions determine whether color sensor output signals are greater than or equal to a predetermined threshold. Variable gain amplifiers amplify the color sensor output signals with a predetermined gain. A color control portion performs color control based on post-amplification signal and obtains luminances of three types of LEDs. Constant current circuits and the PWM circuits drive the three types of LEDs in accordance with control from the color control portion. Gains of the variable gain amplifiers are switched in a stepwise manner so as to become higher as the color sensor output signals become lower. Thus, it is possible to perform color control with high accuracy even when darker light is provided.

### BACKGROUND OF THE INVENTION

1. Field of the Invention

The present invention relates to a lighting device for a display device which is provided in a display device such as a liquid crystal display device, and a control circuit thereof.

2. Description of the Related Art

Transmissive and semi-transmissive liquid crystal display devices are provided with a backlight using cold-cathode tubes or LEDs (light emitting diodes). Methods for configuring the backlight with LEDs include, for example, a method with white LEDs, and a method with three types of LEDs, i.e., red, green, and blue LEDs. In the latter method, synthetic light composed of light emitted from the three types of LEDs is used as a backlight, and therefore luminances of the three types of LEDs have to be adjusted such that the synthetic light has a predetermined color (e.g., white).

FIG. 7 is a block diagram illustrating the configuration of a control system for a conventional backlight provided in a liquid crystal display device. In FIG. 7, a color sensor 3 detects the light intensities of red, green, and blue contained in light emitted from a red LED 2r, a green LED 2g, and a blue LED 2b (hereinafter, referred to as “three types of LEDs”), and outputs color sensor output signals Xr, Xg, and Xb.

A backlight control circuit 90 performs color control based on the color sensor output signals Xr, Xg, and Xb, and drives the three types of LEDs. Amplifiers 91r, 91g, and 91b each have a fixed gain G, and amplify their respective color sensor output signals Xr, Xg, and Xb by a factor of “G”. A color control portion 92 performs color control based on post-amplification signals Yr, Yg, and Yb, thereby obtaining luminances of the three types of LEDs, and outputs control signals Cr, Cg, and Cb in accordance with the obtained luminances. Note that the reason why the backlight control circuit 90 is provided with the amplifiers 91r, 91g, and 91b is because the range of the color sensor output signals Xr, Xg, and Xb is narrower than the range of the voltage that can be inputted to the color control portion 92.

Constant current circuits 93r, 93g, and 93b each output constant current. A PWM (pulse width modulation) circuit 94r supplies the red LED 2r with drive current Ir which is a part of a current outputted from the constant current circuit 93r with an amount corresponding to the control signal Cr. The red LED 2r emits light with a luminance corresponding to the amount of drive current Ir. The PWM circuits 94g and 94b, and the green and blue LEDs 2g and 2b operate similarly.

FIG. 8 is a graph illustrating the relationship between the light intensity of each color incident on the color sensor 3 and the output voltages from the amplifiers 91r, 91g, and 91b in the backlight shown in FIG. 7. In the backlight shown in FIG. 7, the output voltages from the amplifiers 91r, 91g, and 91b (the voltages of the post-amplification signals Yr, Yg, and Yb) are respectively proportional to the light intensities of red, green, and blue contained in light incident on the color sensor 3, as shown in FIG. 8. For example, when the light intensity of red contained in the light incident on the color sensor 3 is at a maximum detectable value Emax, the output voltage from the amplifier 91r is at a maximum value Vmax.

In the case of using the backlight shown in FIG. 7, color control needs to be performed in advance prior to use. In the color control prior to use, maximum drive current is initially supplied to each of the three types of LEDs. Thereafter, the control signals Cr, Cg, and Cb are adjusted such that a predetermined backlighting color is provided. When the predetermined backlighting color is obtained, the color control portion 92 memorizes the luminance ratio among the three types of LEDs. When the backlight is used later, the color control portion 92 obtains the luminances of the three types of LEDs such that the luminance ratio among the three types of LEDs matches the previously memorized luminance ratio among the three types of LEDs, and outputs the control signals Cr, Cg, and Cb in accordance with the obtained luminances. Thus, when the backlight is used, it is possible to perform color control such that a predetermined backlighting color is provided.

Note that as for the backlight control circuit provided with the three types of LEDs, the following technologies are known conventionally. Japanese Laid-Open Patent Publication No. 10-49074 discloses that predetermined color balance among color light sources is kept constant by providing a field sequential display device with optical sensors for detecting luminance levels of the color light sources, and light intensity control circuits for supplying light intensity control signals to light source drive circuits in accordance with the values detected by the optical sensors. Japanese Laid-Open Patent Publication No. 2004-21147 discloses a planar light source device including a light guide plate for guiding light from light sources across an entire plane, and a sensor for detecting light from the light sources, in which the light intensities of the light sources are adjusted based on the values detected by the sensor. Japanese Laid-Open Patent Publication No. 2004-184852 discloses a display device for displaying an image on a display plane by illuminating a light modulation device with light from light emitting bodies, in which, when adjusting color balance on the display plane in accordance with the intensities of light received from the light emitting bodies, the colors of light emitted from the light emitting bodies relating to the intensities of the received light can be identified.

Liquid crystal display devices are provided with a function of adjusting the brightness of the backlight in accordance with ambient brightness and user settings in order to reduce power consumption and facilitate easy viewing of the screen. For example, the brightness of the backlight can be switched in a stepwise or progressive manner from zero to the maximum value. In this case, it is necessary to perform color control such that a predetermined backlighting color is always provided even when the brightness of the backlight changes.

In the backlight shown in FIG. 7, adjustment data P is inputted to the color control portion 92 in order to adjust the brightness. The color control portion 92 obtains the luminances of the three types of LEDs based on the adjustment data P, as well as based on the post-amplification signals Yr, Yg, and Yb. The three types of LEDs emit light with the luminances thus obtained. Accordingly, the brightness of the backlight can be adjusted using the adjustment data P.

In the backlight shown in FIG. 7, noise always occurs in the post-amplification signals Yr, Yg, and Yb due to limited sensitivity of the color sensor 3, and characteristics of the amplifiers 91r, 91g, and 91b. The level of the noise is substantially constant regardless of the levels of the post-amplification signals Yr, Yg, and Yb. Accordingly, as the color sensor output signals Xr, Xg, and Xb become lower (as the backlight becomes darker), the proportion of the noise contained in the post-amplification signals Yr, Yg, and Yb becomes higher (i.e., the S/N ratios of the post-amplification signals Yr, Yg, and Yb become lower).

However, in the backlight control circuit 90, the color sensor output signals Xr, Xg, and Xb are amplified by a factor of “G” in a fixed manner, and the color control portion 92 performs the same color control regardless of the levels of the post-amplification signals Yr, Yg, and Yb. Therefore, when the post-amplification signals Yr, Yg, and Yb with low S/N ratios are inputted because the backlight is dark, the accuracy of the color control by the color control portion 92 is reduced. In this manner, the conventional backlight shown in FIG. 7 has a problem where the accuracy of the color control is reduced when it provides darker light.

### SUMMARY OF THE INVENTION

In order to overcome the problems described above, preferred embodiments of the present invention provide a lighting device for a display device capable of performing color control with high accuracy even when darker light is provided, and a control circuit thereof. A first preferred embodiment of the present invention is directed to a lighting device provided in a display device, including a plurality of light emission portions arranged to emit light that is different in color from one another, a color sensor arranged to detect the light intensity of each color contained in the light emitted from the light emission portions, and a control circuit arranged to perform color control based on output signals from the color sensor, and to drive the light emission portions, wherein the control circuit includes amplification portions arranged to amplify the output signals from the color sensor, a color control portion arranged to perform color control based on the signals amplified by the amplification portions, thereby obtaining luminances of the light emission portions, and to output control signals in accordance with the obtained luminances, and drive portions arranged to drive the light emission portions based on the control signals, and the amplification portions have gains to be switched in accordance with levels of the output signals from the color sensor.

The gains of the amplification portions are preferably switched in a stepwise manner so as to become higher as the output signals from the color sensor become lower.

The range of the output signals from the color sensor is preferably divided into a plurality of sections, and the gains of the amplification portions which are used when the output signals from the color sensor fall within one of the sections that have values each obtained by dividing the maximum value of a signal that can be inputted into the color control portion by the maximum value within the section.

The color control portion preferably obtains the luminances of the light emission portions based on externally provided adjustment data, as well as based on the signals amplified by the amplification portions.

The light emission portions preferably include light emitting diodes.

The drive portions preferably include constant current circuits, and pulse width modulation circuits arranged to supply the light emission portions with current outputted from the constant current circuits with amounts corresponding to the control signals. Another preferred embodiment of the present invention is directed to a control circuit provided in a lighting circuit for a display device including a plurality of light emission portions arranged to emit light that is different in color from one another, and a color sensor arranged to detect the light intensity of each color contained in light emitted from the light emission portions, the control circuit including amplification portions arranged to amplify output signals from the color sensor, a color control portion arranged to perform color control based on the signals amplified by the amplification portions, thereby obtaining luminances of the light emission portions, and to output control signals in accordance with the obtained luminances, and drive portions arranged to drive the light emission portions based on the control signals, wherein the amplification portions have gains to be switched in accordance with levels of the output signals from the color sensor.

According to yet another preferred embodiment of the present invention, a display device includes a display panel, and a lighting device for a display device according to any of the above-described preferred embodiments of the present invention, the lighting device being arranged to irradiate one surface of the display panel with light.

According to a preferred embodiment of the present invention, characteristics of the post-amplification signals can be improved by switching the gains for use in amplifying the output signals from the color sensor in accordance with the levels of the output signals from the color sensor. Thus, it is possible to increase the accuracy of color control performed with the post-amplification signals.

According to a preferred embodiment of the present invention, when the output signals from the color sensor are low (when the backlight is dark), the gains for use in amplifying the output signals from the color sensor become higher, and therefore the proportion of the noise contained in the post-amplification signals is reduced, which increases the accuracy of the color control performed with the post-amplification signals. Thus, it is possible to perform color control with high accuracy even when darker light is provided.

According to a preferred embodiment of the present invention, the gains for use in amplifying the output signals from the color sensor can be switched in a stepwise manner in accordance with the sections within which the output signals from the color sensor fall, thereby maximizing the gains within each section. Thus, it is possible to further increase the accuracy of the color control.

According to a preferred embodiment of the present invention, it is possible to control the brightness of the lighting device for a display device using the adjustment data.

According to a preferred embodiment of the present invention, the light emitting diodes are used to facilitate easy configuration of the light emission portions emitting light that is different in color from one another.

According to a preferred embodiment of the present invention, the constant current circuits and the pulse width modulation circuits are used to facilitate easy configuration of the drive portions for driving the light emission portions based on the control signals.

According to a preferred embodiment of the present invention, it is possible to achieve a lighting device control circuit for a display device which is to be provided in a lighting device for a display device capable of performing color control with high accuracy using the post-amplification signals.

According to a preferred embodiment of the present invention, it is possible to achieve a display device having a lighting device for a display device capable of performing color control with high accuracy using the post-amplification signals.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating the configuration of a control system for a backlight according to a preferred embodiment of the present invention.

FIG. 2 is a diagram illustrating the configuration of a liquid crystal display device provided with the backlight shown in FIG. 1.

FIG. 3 is a graph illustrating the relationship between the light intensity of each color incident on a color sensor and the output voltages from variable gain amplifiers in the backlight shown in FIG. 1.

FIG. 4A is a graph illustrating the fluctuation range of the output voltage from an amplifier in a conventional backlight.

FIG. 4B is a graph illustrating the fluctuation range of the output voltage from the amplifier in the backlight shown in FIG. 1.

FIG. 5A is a graph illustrating the relationship between the light intensity of each color incident on a color sensor and the output voltages from variable gain amplifiers in a backlight according to a first variant of a preferred embodiment of the present invention.

FIG. 5B is a graph illustrating the relationship between the light intensity of each color incident on a color sensor and the output voltages from variable gain amplifiers in a backlight according to a second variant of a preferred embodiment of the present invention.

FIG. 6A is a graph illustrating the relationship between the light intensity of each color incident on a color sensor and the output voltages from variable gain amplifiers in a backlight according to a third variant of a preferred embodiment of the present invention.

FIG. 6B is a graph illustrating the relationship between the light intensity of each color incident on a color sensor and the output voltages from variable gain amplifiers in a backlight according to a fourth variant of a preferred embodiment of the present invention.

FIG. 7 is a block diagram illustrating the configuration of a control system for the conventional backlight.

FIG. 8 is a graph illustrating the relationship between the light intensity of each color incident on a color sensor and the output voltages from the amplifiers in the conventional backlight.

### DETAILED DESCRIPTION OF THE PREFERRED EMBODIMENTS

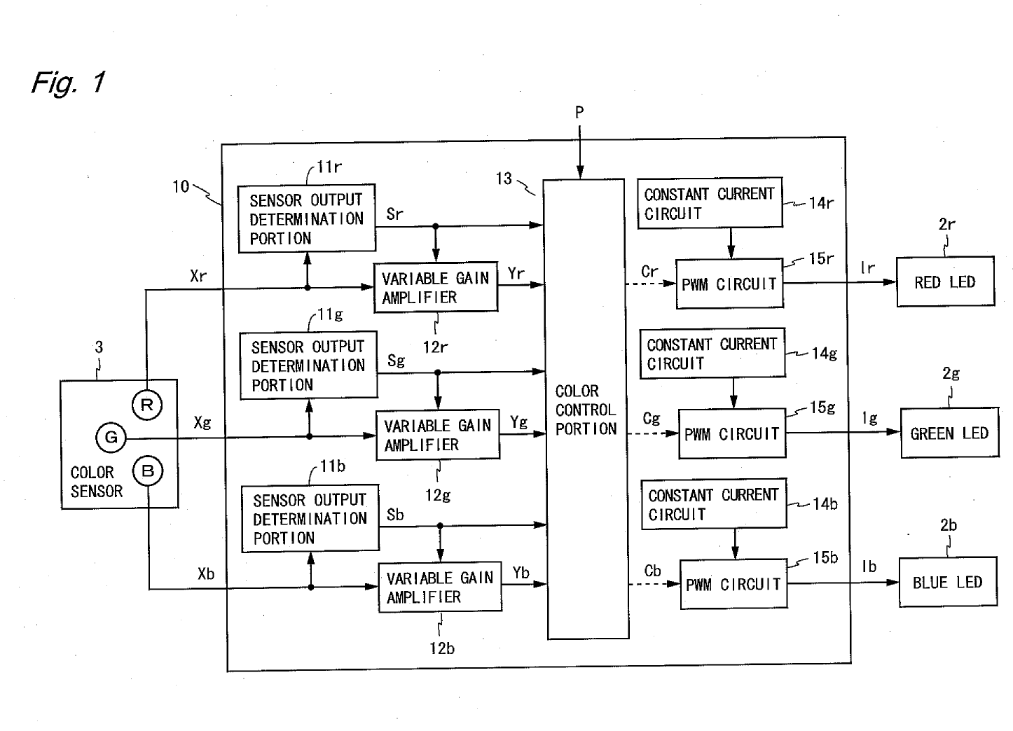

FIG. 1 is a block diagram illustrating the configuration of a control system for a backlight according to a preferred embodiment of the present invention. The backlight shown in FIG. 1 includes a red LED 2r, a green LED 2g, a blue LED 2b, a color sensor 3, and a backlight control circuit 10. The backlight control circuit 10 includes sensor output determination portions 11r, 11g, and 11b, variable gain amplifiers 12r, 12g, and 12b, a color control portion 13, constant current circuits 14r, 14g, and 14b, and PWM circuits 15r, 15g, and 15b. Note that in the following description, alphabetical letters postfixed to reference characters are omitted to make generic reference to three components of the same type (e.g., the sensor output determination portions 11r, 11g, and 11b are generically referred to as the “sensor output determination portions 11”).

In FIG. 1, the red LED 2r, the green LED 2g, and the blue LED 2b emit red light, green light, and blue light, respectively, in accordance with control from the backlight control circuit 10. The color sensor 3 detects the light intensities of red, green, and blue contained in the light emitted from the three types of LEDs, and outputs color sensor output signals Xr, Xg, and Xb in accordance with the light intensity of each color. Such a color sensor 3 consists of, for example, three types of filters for transmitting red light, green light, and blue light therethrough, and three light detecting elements (e.g., photodiodes). Note that the color sensor output signals Xr, Xg, and Xb may be either voltage or current signals.

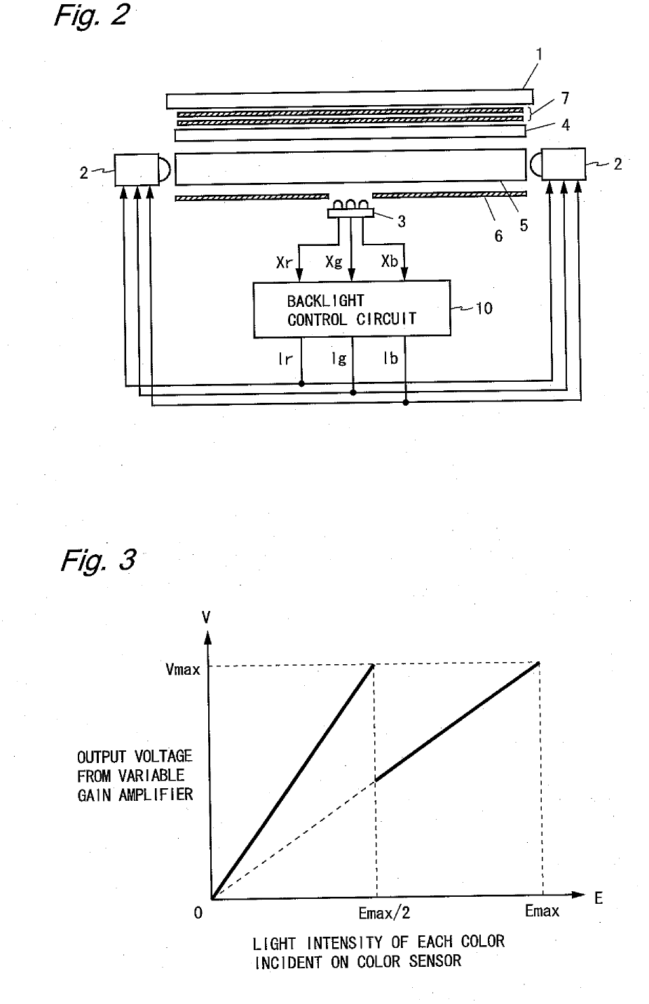

FIG. 2 is a diagram illustrating the configuration of a liquid crystal display device provided with the backlight shown in FIG. 1. The liquid crystal display device shown in FIG. 2 includes a liquid crystal panel 1, and the backlight for irradiating the back of the liquid crystal panel 1 with light. The backlight includes the LEDs 2 (in FIG. 1, the red LED 2r, the green LED 2g, and the blue LED 2b), the color sensor 3, a diffusion plate 4, a light guide plate 5, a reflection plate 6, and the backlight control circuit 10. An optical sheet 7 is provided between the liquid crystal panel 1 and the backlight.

The liquid crystal panel 1 is driven by a drive circuit (not shown) to display a screen. The LEDs 2 emit light in accordance with control from the backlight control circuit 10. The light emitted from the LEDs 2 is incident on the light guide plate 5. The light guide plate 5 is provided with the diffusion plate 4 on one surface, and the reflection plate 6 on the other surface. The light incident on the light guide plate 5 is reflected by the reflection plate 6 so as to propagate through the light guide plate 5, and is diffused by the diffusion plate 4 before being transmitted through the optical sheet 7 to be incident on the liquid crystal panel 1. The reflection plate 6 has an opening provided therein, and the color sensor 3 is provided in the vicinity of the opening. Light passing through the opening is incident on the color sensor 3.

Referring again to FIG. 1, the backlight control circuit 10 will be described below in detail. The backlight control circuit 10 performs color control based on the color sensor output signals Xr, Xg, and Xb, and drives the three types of LEDs. In the backlight control circuit 10, the sensor output determination portions 11 and their respective variable gain amplifiers 12 function as amplification portions, and the constant current circuits 14 and their respective PWM circuits 15 function as drive portions. In addition, the red LED 2r, the green LED 2g, and the blue LED 2b constitute light emission portions for emitting light different in color from one another. Note that in FIG. 1, each light emission portion is provided with one LED, but the light emission portion may include a plurality of LEDs.

The sensor output determination portion 11r determines whether the color sensor output signal Xr is greater than or equal to a predetermined threshold, and outputs a determination signal Sr indicating the result. Similarly, the sensor output determination portions 11g and 11b respectively output determination signals Sg and Sb indicating whether the color sensor output signals Xg and Xb are greater than or equal to their respective predetermined thresholds. The thresholds for the sensor output determination portions 11 may be the same as or different from one another. In the following, it is assumed that the sensor output determination portions 11 output determination signals at high level when the color sensor output signals are greater than or equal to the thresholds, and at low level when the color sensor output signals are less than the thresholds.

The variable gain amplifier 12r amplifies the color sensor output signal Xr and outputs the post-amplification signal Yr. The gain of the variable gain amplifier 12r is switched in accordance with the determination signal Sr. More specifically, the gain of the variable gain amplifier 12r when the determination signal Sr is at low level is higher than the gain of the variable gain amplifier 12r when the determination signal Sr is at high level. The post-amplification signal Yr outputted by the variable gain amplifier 12r is a signal obtained by amplifying the color sensor output signal Xr with a relatively low gain when the determination signal Sr is at high level, or a signal obtained by amplifying the color sensor output signal Xr with a relatively high gain when the determination signal Sr is at low level.

Similarly, the gain of the variable gain amplifier 12g when the determination signal Sg is at low level is higher than the gain of the variable gain amplifier 12g when the determination signal Sg is at high level. The post-amplification signal Yg outputted by the variable gain amplifier 12g is a signal obtained by amplifying the color sensor output signal Xg with a relatively low gain when the determination signal Sg is at high level, or a signal obtained by amplifying the color sensor output signal Xg with a relatively high gain when the determination signal Sg is at low level. In addition, the gain of the variable gain amplifier 12b when the determination signal Sb is at low level is higher than the gain of the variable gain amplifier 12b when the determination signal Sb is at high level, and the post-amplification signal Yb outputted by the variable gain amplifier 12b is a signal obtained by amplifying the color sensor output signal Xb with a relatively low gain when the determination signal Sb is at high level, or a signal obtained by amplifying the color sensor output signal Xb with a relatively high gain when the determination signal Sb is at low level. In this manner, the gains of the variable gain amplifiers 12 are switched in a stepwise manner so as to become higher as the color sensor output signals become lower.

Inputted to the color control portion 13 are the determination signals Sr, Sg, and Sb outputted from the sensor output determination portions 11, the post-amplification signals Yr, Yg, and Yb outputted from the variable gain amplifiers 12, and externally provided adjustment data P. The adjustment data P contains data for adjusting the brightness and color temperature of the backlight. The adjustment data P is provided by, for example, the user of the liquid crystal display device.

The color control portion 13 performs color control based on these input signals, thereby obtaining luminances of the three types of LEDs, and outputs control signals Cr, Cg, and Cb in accordance with the obtained luminances. More specifically, the color control portion 13 has memorized therein the luminance ratio among the three types of LEDs that has been obtained by color control prior to use of the backlight. When using the backlight, the color control portion 13 obtains the luminances of the three types of LEDs such that the luminance ratio among the three types of LEDs matches the memorized ratio, and outputs the control signals Cr, Cg, and Cb in accordance with the obtained luminances.

At this time, the post-amplification signals Yr, Yg, and Yb inputted to the color control portion 13 may be obtained by amplification with relatively low gains or by amplification with relatively high gains. Therefore, in order to perform color control based on these two types of signals, the color control portion 13 performs a scaling process before performing the color control. More specifically, in the scaling process, when the determination signal Sr is at low level, the post-amplification signal Yr is multiplied by [(the lower gain of the variable gain amplifier 12r)/(the higher gain of the variable gain amplifier 12r)]. Similarly, when the determination signal Sg is at low level, the post-amplification signal Yg is multiplied by [(the lower gain of the variable gain amplifier 12g)/(the higher gain of the variable gain amplifier 12g)], and when the determination signal Sb is at low level, the post-amplification signal Yb is multiplied by [(the lower gain of the variable gain amplifier 12b)/(the higher gain of the variable gain amplifier 12b)].

In addition, the color control portion 13 obtains the luminances of the three types of LEDs based on the adjustment data P, as well as based on the determination signals Sr, Sg, and Sb and the post-amplification signals Yr, Yg, and Yb. For example, when the adjustment data P contains data indicating that the brightness of the backlight is to be halved, the color control portion 13 halves the luminances of the three types of LEDs compared to their normal levels. Alternatively, when the adjustment data P contains data indicating that backlighting is to be rendered slightly red, the color control portion 13 raises the luminance of the red LED 2r to a level higher than normal, while reducing the luminances of the green LED 2g and the blue LED 2b to a level lower than normal.

The constant current circuits 14r, 14g, and 14b each supply constant current. The PWM circuit 15r supplies the red LED 2r with drive current Ir which is a part of current outputted from the constant current circuit 14r with an amount corresponding to the control signal Cr. Once supplied with the drive current Ir, the red LED 2r emits light with a luminance corresponding to the amount of drive current Ir. Similarly, the PWM circuit 15g supplies the green LED 2g with drive current Ig which is a part of current outputted from the constant current circuit 14g with an amount corresponding to the control signal Cg, and the green LED 2g emits light with a luminance corresponding to the amount of drive current Ig. The PWM circuit 15b supplies the blue LED 2b with drive current Ib which is a part of current outputted from the constant current circuit 14b with an amount corresponding to the control signal Cb, and the blue LED 2b emits light with a luminance corresponding to the amount of drive current Ib.

An exemplary method for deciding the thresholds for the sensor output determination portions 11 and the gains of the variable gain amplifiers 12 will be described below. In the backlight control circuit 10, when the range of the color sensor output signals Xr, Xg, and Xb is divided into a plurality of sections as described below, and the color sensor output signals Xr, Xg, and Xb fall within a given section, the gains of the variable gain amplifiers 12 are decided to values each obtained by dividing the maximum value of a signal that can be inputted to the color control portion 13 by the maximum value within the section.

A specific example will be described where the minimum value and the maximum value of the light intensity of red that can be detected by the color sensor 3 are 0 and Emax, respectively, the minimum value and the maximum value of the color sensor output signal Xr are 0 and Umax, respectively, the minimum value and the maximum value of the voltage that can be inputted to the color control portion 13 are 0 and Vmax, respectively, and the range of the color sensor output signal Xr (the range from 0 to Umax) is divided into two equal sections. In this case, the threshold for the sensor output determination portion 11r is decided to Umax/2, the lower gain of the variable gain amplifier 12r is decided to Vmax/Umax, and the higher gain of the variable gain amplifier 12r is decided to twice the value, i.e., (2×Vmax/Umax).

When the threshold and the gains are decided in this manner, if the light intensity of red incident on the color sensor 3 is greater than or equal to Emax/2, the sensor output determination portion 11r outputs the determination signal Sr at high level, and the variable gain amplifier 12r amplifies the color sensor output signal Xr by a factor of (Vmax/Umax). On the other hand, if the light intensity of red incident on the color sensor 3 is less than Emax/2, the sensor output determination portion 11r outputs the determination signal Sr at low level, and the variable gain amplifier 12r amplifies the color sensor output signal Xr by a factor of (2×Vmax/Umax).

The gains of the variable gain amplifiers 12g and 12b are decided in a manner similar to the gains of the variable gain amplifier 12r. Accordingly, in the case of the backlight shown in FIG. 1, the relationship between the light intensity of each color incident on the color sensor 3 and the output voltages from the variable gain amplifiers 12 is given as shown in FIG. 3.

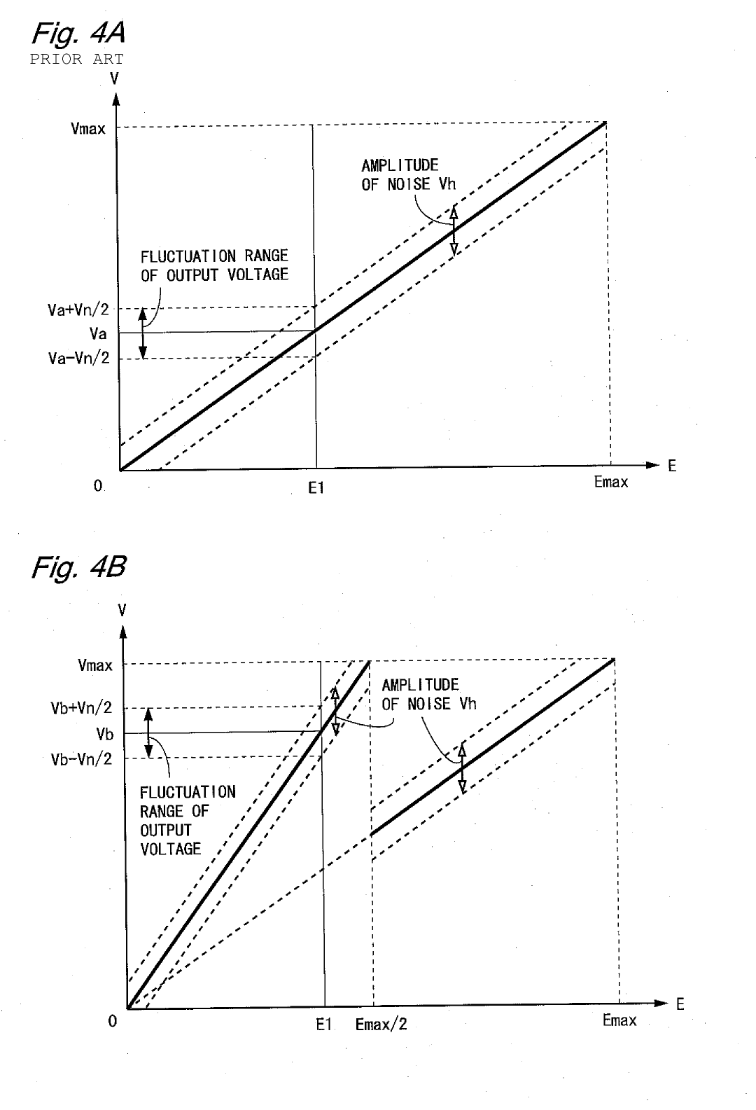

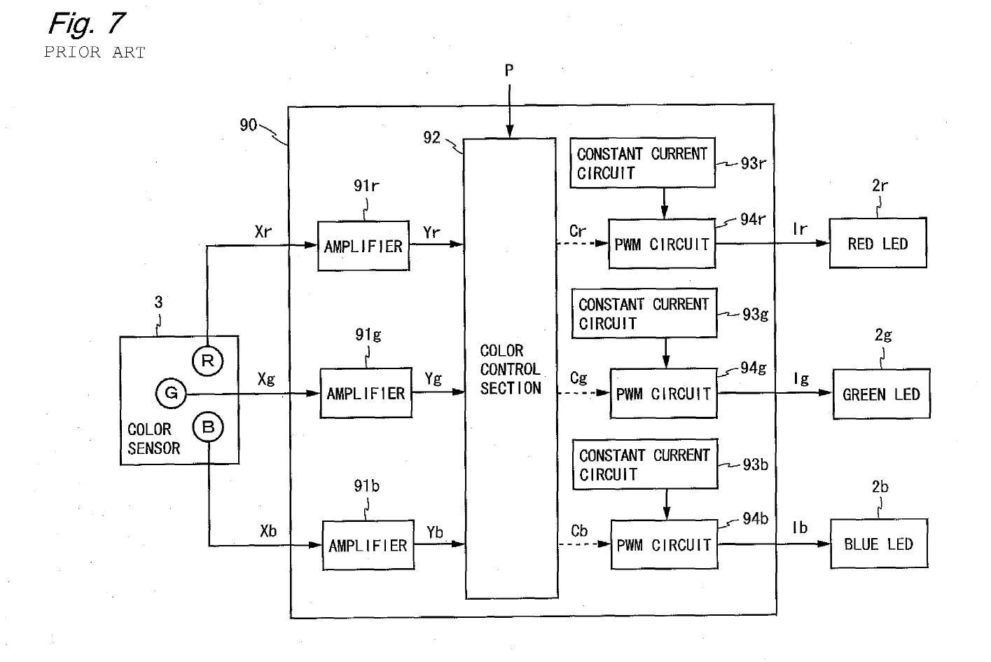

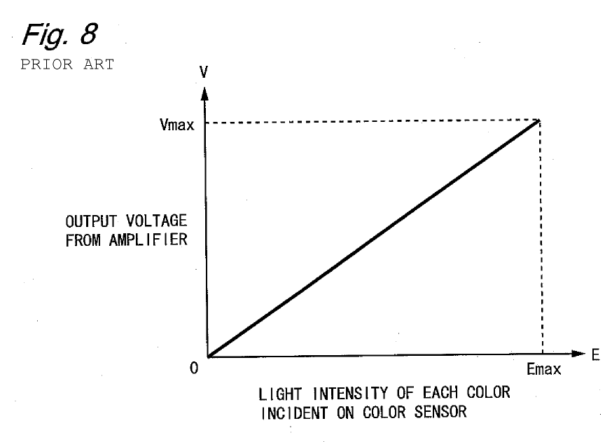

Referring to FIGS. 4A and 4B, the effect of the backlight according to the present preferred embodiment will be described below. FIG. 4A is a graph illustrating the fluctuation range of the output voltage from the amplifier 91 in the conventional backlight (FIG. 7), and FIG. 4B is a graph illustrating the fluctuation range of the output voltage from the variable gain amplifier 12 in the backlight according to the present embodiment (FIG. 1). Here, an example is described where the light intensity of red incident on the color sensor 3 is E1, which is smaller than Emax/2, i.e., half of the maximum value.

In the conventional backlight, the color sensor output signal Xr is amplified by a factor of (Vmax/Umax) by the amplifier 91r having a fixed gain (see FIG. 4A). On the other hand, in the backlight according to the present preferred embodiment, when E1<Emax/2, the color sensor output signal Xr is amplified by a factor of (2×Vmax/Umax) with the higher gain of the variable gain amplifier 12r. Accordingly, when the light intensity of red incident on the color sensor 3 is E1 (E1<Emax/2), the output voltage Vb of the variable gain amplifier 12r in the backlight according to the present preferred embodiment is twice the output voltage Va of the amplifier 91r in the conventional backlight.

In the backlight according to the present preferred embodiment also, noise always occurs in the post-amplification signal Yr due to limited sensitivity of the color sensor 3 and characteristics of the variable gain amplifier 12, as in the conventional backlight. The level of the noise is substantially constant regardless of the level of the post-amplification signal Yr. When the amplitude of the noise is taken as Vn, the output voltage (the voltage of the post-amplification signal Yr) from the amplifier 91r in the conventional backlight fluctuates within the range from (Va−Vn/2) to (Va+Vn/2) (see FIG. 4A). On the other hand, in the backlight according to the present preferred embodiment, the output voltage (the voltage of the post-amplification signal Yr) from the variable gain amplifier 12 fluctuates within the range from (Vb−Vn/2) to (Vb+Vn/2) (see FIG. 4B).

However, the output voltage Vb of the variable gain amplifier 12r in the backlight according to the present preferred embodiment is twice the output voltage Va of the amplifier 91r in the conventional backlight, as described above. Accordingly, if noise of the same level occurs in the post-amplification signal Yr, the proportion of the noise contained in the post-amplification signal Yr is lower in the backlight according to the present preferred embodiment than in the conventional backlight. For example, when Va=2V, Vb=4V, and Vn=0.2V, the proportion of the noise contained in the post-amplification signal Yr is 0.2/4=5% in the backlight according to the present preferred embodiment, while it is 0.2/2=10% in the conventional backlight. In this manner, when the color sensor output signal Xr is less than Emax/2, i.e., half of the maximum value, the S/N ratio of the post-amplification signal Yr is higher in the backlight according to the present preferred embodiment than in the conventional backlight.

For a similar reason, when the color sensor output signals Xg and Xb are less than half of their maximum values, the S/N ratios of the post-amplification signals Yg and Yb are higher in the backlight according to the present preferred embodiment than in the conventional backlight. In this manner, when the color sensor output signals Xr, Xg, and Xb are less than half of their maximum values, the post-amplification signals Yr, Yg, and Yb with their S/N ratios higher than conventionally are inputted, and therefore the accuracy of color control by the color control portion 13 is increased. Thus, the backlight according to the present preferred embodiment allows color control with darker light to be performed with higher accuracy than conventionally.

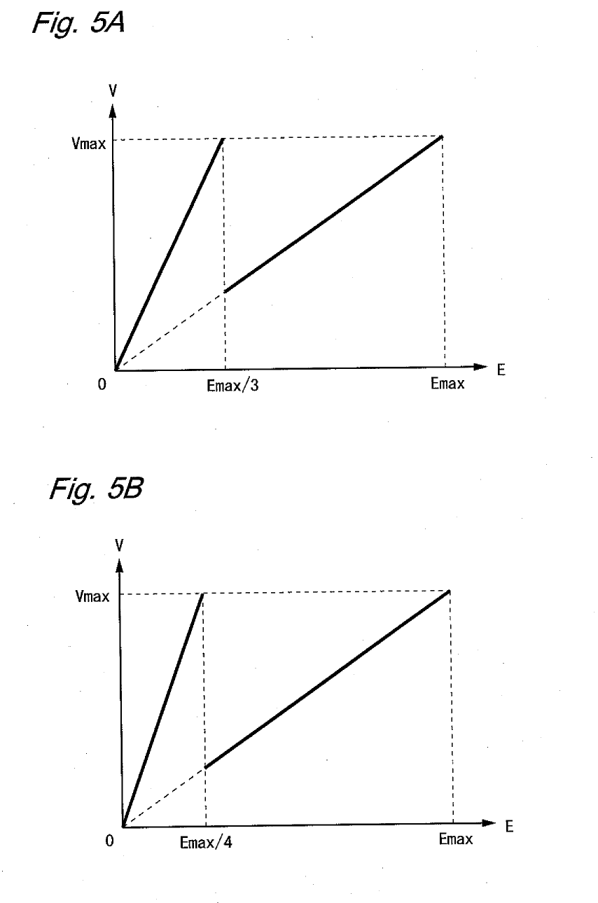

While the foregoing description has been provided with respect to the case where the range of the color sensor output signals Xr, Xg, and Xb (hereinafter, referred to as the “sensor output range”) is preferably divided into two equal sections, the sensor output range may be divided into unequal sections or may be divided into three sections or more. For example, when the sensor output range is divided into two sections at a ratio of 1:2, the thresholds for the sensor output determination portions 11 are decided to Umax/3, the lower gains of the variable gain amplifiers 12 are decided to Vmax/Umax, and the higher gains of the variable gain amplifiers 12 are decided to three times the value, i.e., (3×Vmax/Umax). In this case, the relationship between the light intensity of each color incident on the color sensor 3 and the output voltages from the variable gain amplifiers 12 is as shown in FIG. 5A.

In addition, when the sensor output range is divided into two sections at a ratio of 1:3, the thresholds for the sensor output determination portions 11 are decided to Umax/4, the lower gains of the variable gain amplifiers 12 are decided to Vmax/Umax, and the higher gains of the variable gain amplifiers 12 are decided to four times the value, i.e., (4×Vmax/Umax). In this case, the relationship between the light intensity of each color incident on the color sensor 3 and the output voltages from the variable gain amplifiers 12 is as shown in FIG. 5B.

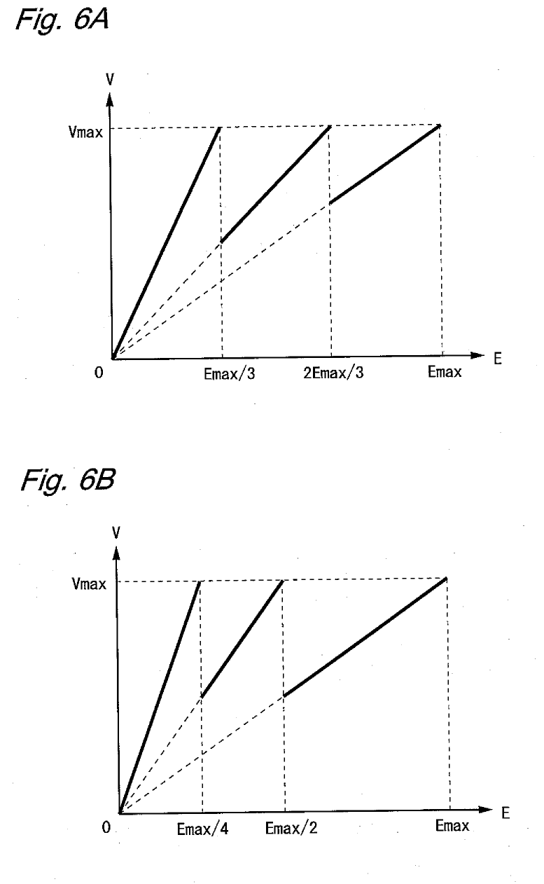

In addition, when the sensor output range is divided into three equal sections, the thresholds for the sensor output determination portions 11 are decided to Umax/3 and 2×Umax/3, and the gains of the variable gain amplifiers 12 are decided to Vmax/Umax, (3/2)×Vmax/Umax, and 3×Vmax/Umax. In this case, the relationship between the light intensity of each color incident on the color sensor 3 and the output voltages from the variable gain amplifiers 12 is as shown in FIG. 6A.

In addition, when the sensor output range is divided into three sections at a ratio of 1:1:2, the thresholds for the sensor output determination portions 11 are decided to Umax/4 and Umax/2, and the gains of the variable gain amplifiers 12 are decided to Vmax/Umax, 2×Vmax/Umax, and 4×Vmax/Umax. In this case, the relationship between the light intensity of each color incident on the color sensor 3 and the output voltages from the variable gain amplifiers 12 is as shown in FIG. 6B.

As described above, the backlight according to the present preferred embodiment allows the characteristics of the post-amplification signals Yr, Yg, and Yb to be improved by switching the gains for use in amplifying the color sensor output signals Xr, Xg, and Xb in accordance with the levels of the color sensor output signals Xr, Xg, and Xb. Thus, it is possible to increase the accuracy of the color control performed with the post-amplification signals Yr, Yg, and Yb.

Also, in the backlight according to the present preferred embodiment, the gains for use in amplifying the color sensor output signals Xr, Xg, and Xb are switched in a stepwise manner so as to become higher as the color sensor output signals Xr, Xg, and Xb become lower. Accordingly, when the color sensor output signals Xr, Xg, and Xb are low (when the backlight is dark), the proportion of the noise contained in the post-amplification signals Yr, Yg, and Yb is reduced, which increases the accuracy of the color control performed with the post-amplification signals Yr, Yg, and Yb. Thus, it is possible to perform the color control with high accuracy even when the backlight is dark.

Particularly, in the backlight according to the present preferred embodiment, the gains which are used when the color sensor output signals Xr, Xg, and Xb fall within one of the sections are decided to values each obtained by dividing the maximum value Vmax of a signal that can be inputted to the color control portion 13 by the maximum value within the section. Accordingly, the gains for use in amplifying the color sensor output signals Xr, Xg, and Xb can be switched in a stepwise manner in accordance with the sections within which the color sensor output signals Xr, Xg, and Xb fall, thereby maximizing the gains within each section. Thus, it is possible to further increase the accuracy of the color control.

Note that the foregoing description has been provided with respect to the case where the backlight according to the present preferred embodiment is provided in the liquid crystal display device, but this is not restrictive, and the backlight according to the present preferred embodiment may be provided in any display device which requires backlighting. In addition, the light emission portions have been described as having the red LED, the green LED, and the blue LED provided therein, but LEDs having any color other than these may be provided, or any light emission elements other than the LEDs may be provided.

The lighting device for a display device according to a preferred embodiment of the present invention has such an effect as to be able to perform color control with high accuracy even when darker light is provided, and therefore can be used in various display devices which require a lighting device, including the liquid crystal display device.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-8. (canceled)

9. A lighting device for a display device, the lighting device being provided in the display device and comprising:
a plurality of light emission portions arranged to emit light that is different in color from one another;
a color sensor arranged to detect light intensity of each color contained in the light emitted from the light emission portions; and
a control circuit arranged to perform color control based on output signals from the color sensor, and to drive the light emission portions; wherein
the control circuit includes:
amplification portions arranged to amplify the output signals from the color sensor;
a color control portion arranged to perform color control based on the signals amplified by the amplification portions, thereby obtaining luminances of the light emission portions, and to output control signals in accordance with the obtained luminances; and
drive portions arranged to drive the light emission portions based on the control signals, and
the amplification portions have gains to be switched in accordance with levels of the output signals from the color sensor.

10. The lighting device for a display device according to claim 9, wherein the gains of the amplification portions are switched in a stepwise manner so as to become higher as the output signals from the color sensor become lower.

11. The lighting device for a display device according to claim 10, wherein the range of the output signals from the color sensor is divided into a plurality of sections, and the gains of the amplification portions which are used when the output signals from the color sensor fall within one of the sections have values each obtained by dividing the maximum value of a signal that can be inputted into the color control portion by the maximum value within the section.

12. The lighting device for a display device according to claim 9, wherein the color control portion obtains the luminances of the light emission portions based on externally provided adjustment data, as well as based on the signals amplified by the amplification portions.

13. The lighting device for a display device according to claim 9, wherein the light emission portions include light emitting diodes.

14. The lighting device for a display device according to claim 9, wherein the drive portions include constant current circuits, and pulse width modulation circuits arranged to supply the light emission portions with current outputted from the constant current circuits with amounts corresponding to the control signals.

15. A control circuit provided in a lighting circuit for a display device including a plurality of light emission portions arranged to emit light that is different in color from one another, and a color sensor arranged to detect the light intensity of each color contained in light emitted from the light emission portions, the control circuit comprising:
amplification portions arranged to amplify output signals from the color sensor;
a color control portion arranged to perform color control based on the signals amplified by the amplification portions, thereby obtaining luminances of the light emission portions, and to output control signals in accordance with the obtained luminances; and
drive portions arranged to drive the light emission portions based on the control signals; wherein
the amplification portions have gains to be switched in accordance with levels of the output signals from the color sensor.

16. A display device, comprising:
a display panel; and
a lighting device for a display device of claim 9, the lighting device being arranged to irradiate one surface of the display panel with light.
